(19) United States
(12) Patent Application Publication
(10) Pub. No.: US 2015/0046260 A1
(43) Pub. Date: Feb. 12, 2015

(54) USING ENTITIES IN CONTENT SELECTION

(71) Applicant: Google Inc., Mountain View, CA (US)

(72) Inventors: Lars Engebretsen, Mountain View, CA (US); Jennifer J. Huang, Mountain View, CA (US); Thomas Hofmann, Mountain View, CA (US)

(21) Appl. No.: 14/361,671

(22) PCT Filed: Jul. 22, 2013
(86) PCT No.: PCT/SE2013/050923

§ 371 Date: Oct. 10, 2014

(51) Int. Cl. G06Q 30/02

(52) U.S. Cl. CPC G06Q 30/0256
USPC 705/14.54

(57) ABSTRACT

Methods, systems, and apparatus, including computer programs encoded on a computer-readable storage medium, for comparing a request entity to a campaign entity. A method includes: identifying a campaign associated with a content sponsor, the campaign having an associated creative for presentation to users and selection criteria for use in evaluating when to present the creative in response to received requests for content; receiving at least one keyword from the content sponsor to be used as selection criteria; identifying an entity from a plurality of entities to associate with the keyword; storing the identified entity along with the keyword in association with the campaign; and using the keyword and the identified entity when evaluating the received requests for content.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for associating an entity with a keyword. The method comprises: identifying a campaign associated with a content sponsor, the campaign having an associated creative for presentation to users and selection criteria for use in evaluating when to present the creative in response to received requests for content; receiving at least one keyword from the content sponsor to be used as selection criteria; identifying an entity from a plurality of entities to associate with the keyword; storing the identified entity along with the keyword in association with the campaign; and using the keyword and the identified entity when evaluating the received requests for content.

These and other implementations can each optionally include one or more of the following features. An entity can be named and associated with one or more of a person, a place, a product, a service, a vertical, a concept, or an abstract idea. The keyword can be a broad keyword. Identifying an entity can include: identifying candidate entities based at least in part on historical query data; presenting a plurality of candidate entities to the content sponsor in an interface so as to enable selection from among the candidate entities; and receiving a selection of an entity from the presented candidate entities and using the selected entity as the identified entity. Presenting a plurality of candidate entities can include ranking the candidate entities and presenting a pre-determined number of top ranking candidate entities to the content sponsor. Identifying the entity can further include prompting the content sponsor to provide an entity and receiving from the content sponsor a designation of a specific entity. Identifying the entity can further include receiving from a computing system a designation of a specific entity. A request for content can be received. The request can include one or more keywords and an entity designation. The one or more keywords and the entity designation for the request can be compared to the keyword and the identified entity. A determination can be made that a match exists based on the comparing. The campaign can be identified, based at least in part on the determining, as a candidate to use in response to the received request. The identified entity can be a negative entity. A request for content can be received wherein the request includes one or more keywords and an entity designation. The one or more keywords and the entity designation for the request can be compared to the keyword and the identified entity. A determination can be made that a match exists based on the comparing. The campaign can be identified, based at least in part on the determining, as not being a candidate to use in response to the received request. An auction can be conducted with all candidate campaigns and a content item to provide can be selected based on results of the auction. The entity designation can be inferred and not explicitly provided by a user. The entity designation can be determined based on one or more criteria selected from the group comprising profile data associated with a user, context of the request, content of a page from whence the request originated, or search results associated with the request. Determining a match can include determining a match only when the identified entity matches the entity designation. The creative can be an advertisement.

In general, another aspect of the subject matter described in this specification can be implemented in methods that include a method for comparing a request entity to a campaign entity. The method includes: receiving a query from a user including at least one query term; identifying an entity from a plurality of entities associated with the query; associating the identified entity with the query; identifying one or more content items for delivery along with search results responsive to the query, wherein identifying one or more content items includes using the entity along with the query to locate a matching content item in an inventory of available content items; and providing the identified one or more content items responsive to the received query.

These and other implementations can each optionally include one or more of the following features. An entity can be named and associated with one or more of a person, a place, a product, a service, a vertical, a concept, or an abstract idea. Identifying an entity can include: identifying candidate entities based at least in part on historical query data; presenting a plurality of candidate entities to a user that submitted the query in an interface so as to enable selection from among the candidate entities; and receiving a selection of an entity from the presented candidate entities. Presenting a plurality of candidate entities can include ranking the candidate entities and presenting a pre-determined number of top ranking candidate entities to the user. Identifying the entity can include prompting the user to provide an entity and receiving from the user a designation of a specific entity. Identifying one or more content items can include: comparing the query and the identified entity with selection criteria associated with content items in inventory; determining that a match exists based on the comparing; and identifying a campaign based on the determining as a candidate to use when providing the identified one or more content items. An auction can be conducted with all candidate campaigns and a content item to provide can be selected based on results of the auction. The entity can be inferred and not explicitly provided by the user. The entity can be determined based on one or more criteria selected from the group comprising profile data associated with the user, context of the request, content of a page from whence the request originated, or search results associated with the request. Determining a match can include determining a match only when the identified entity matches an entity designation associated with a given content item in inventory.

In general, another aspect of the subject matter described in this specification can be implemented in systems. A system includes one or more processors and one or more memory elements including instructions. The instructions, when executed, cause the one or more processors to: identify a campaign associated with a content sponsor, the campaign having an associated creative for presentation to users and selection criteria for use in evaluating when to present the creative in response to received requests for content; receive at least one keyword from the content sponsor to be used as selection criteria; identifying an entity from a plurality of entities to associate with the keyword; store the identified entity along with the keyword in association with the campaign; and use the keyword and the identified entity when evaluating the received requests for content.

These and other implementations can each optionally include one or more of the following features. An entity can be named and associated with one or more of a person, a place, a product, a service, a vertical, a concept, or an abstract idea. The keyword can be a broad keyword. Identifying an entity can include: identifying candidate entities based at least in part on historical query data; presenting a plurality of candidate entities to the content sponsor in an interface so as to enable selection from among the candidate entities; and receiving a selection of an entity from the presented candidate entities and using the selected entity as the identified entity. Presenting a plurality of candidate entities can include ranking the candidate entities and presenting a pre-determined number of top ranking candidate entities to the content sponsor. Identifying the entity can include prompting the content sponsor to provide an entity and receiving from the content sponsor a designation of a specific entity.

In general, another aspect of the subject matter described in this specification can be implemented in computer program products. A computer program product is tangibly embodied in a computer-readable storage device and comprises instructions. The instructions, when executed by a processor, cause the processor to: identify a campaign associated with a content sponsor, the campaign having an associated creative for presentation to users and selection criteria for use in evaluating when to present the creative in response to received requests for content; receive at least one keyword from the content sponsor to be used as selection criteria; identifying an entity from a plurality of entities to associate with the keyword; store the identified entity along with the keyword in association with the campaign; and use the keyword and the identified entity when evaluating the received requests for content.

These and other implementations can each optionally include one or more of the following features. An entity can be named and associated with one or more of a person, a place, a product, a service, a vertical, a concept, or an abstract idea. The keyword can be a broad keyword. Identifying an entity can include: identifying candidate entities based at least in part on historical query data; presenting a plurality of candidate entities to the content sponsor in an interface so as to enable selection from among the candidate entities; and receiving a selection of an entity from the presented candidate entities and using the selected entity as the identified entity. Presenting a plurality of candidate entities can include ranking the candidate entities and presenting a pre-determined number of top ranking candidate entities to the content sponsor.

Particular implementations may realize none, one or more of the following advantages. Content providers can configure selection criteria so that content is provided in response to requests for content when the request matches an entity associated with the selection criteria. A content provider can specify both entities and selection criteria (e.g., keywords) for a content item. Content providers can leverage investment in existing selection criteria configurations by annotating existing selection criteria with one or more entity designations.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a user.

FIG. 2 is a block diagram of an example system for providing content to a user.

FIG. 3 illustrates an example campaign management user interface.

FIG. 4 is a flowchart of an example process for associating an entity with a keyword.

FIG. 5 is a flowchart of an example process for comparing a request entity to a campaign entity.

FIG. 6 is a flowchart of an example process for providing content in response to a received request for content.

FIG. 7 is a block diagram of computing devices that may be used to implement the systems and methods described in this document, as either a client or as a server or plurality of servers.

Like reference numbers and designations in the various drawings indicate like elements.

### DETAILED DESCRIPTION

A campaign associated with a content sponsor can be identified, where the campaign includes a creative for presentation to users and selection criteria for use in evaluating when to present the creative in response to received requests for content. The content sponsor can provide, for example, one or more keywords which can be used as selection criteria for the creative. Other selection criteria are possible. A content management system can identify a named entity (e.g., a person, place, product, service, vertical, concept or abstract idea) to associate with a keyword, store the identified entity in association with the keyword and the campaign, and use the keyword and the identified entity when evaluating the received requests for content.

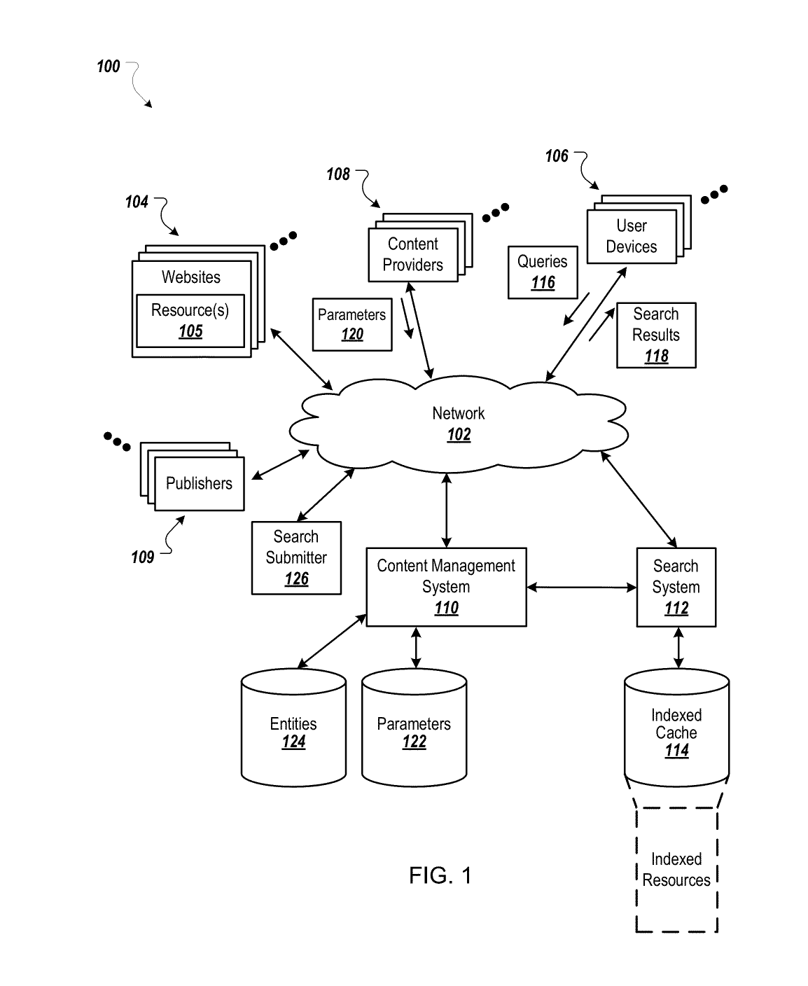

FIG. 1 is a block diagram of an example environment 100 for providing content to a user. The example environment 100 includes a network 102 such as a local area network (LAN), wide area network (WAN), the Internet, or a combination thereof. The network 102 connects websites 104, user devices 106, content providers 108 (e.g., a content provider 108a and a content provider 108b), publishers 109, and a content management system 110. The example environment 100 may include many thousands of websites 104, user devices 106, content providers 108, and publishers 109.

A website 104 includes one or more resources 105 associated with a domain name and hosted by one or more servers. An example website 104 is a collection of webpages formatted in hypertext markup language (HTML) that can contain text, images, multimedia content, and programming elements, e.g., scripts. Each website 104 is maintained by, for example, a publisher 109, e.g., an entity that controls, manages and/or owns the website 104.

A resource 105 is any data that can be provided over the network 102. A resource 105 is identified by a resource address that is associated with the resource 105. Resources 105 include HTML pages, word processing documents, and portable document format (PDF) documents, images, video, and feed sources, to name only a few examples. The resources 105 can include content, e.g., words, phrases, images and sounds that may include embedded information (such as meta-information in hyperlinks) and/or embedded instructions (such as scripts).

To facilitate searching of resources 105, the environment 100 can include a search system 112 that identifies the resources 105, for example, by crawling and indexing the resources 105 provided by the publishers 109 on the websites 104. Data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources 105 over the network 102. Example user devices 106 include personal computers, mobile communication devices, tablet devices, and other devices that can send and receive data over the network 102. A user device 106 typically includes a user application, such as a web browser, to facilitate the sending and receiving of data over the network 102 and the presentation of content to a user.

A user device 106 can request resources 105 from a website 104. In turn, data representing the resource 105 can be provided to the user device 106 for presentation by the user device 106. User devices 106 can also submit search queries 116 to the search system 112 over the network 102. In response to a search query 116, the search system 112 can access the indexed cache 114 to identify resources 105 that are relevant to the search query 116. The search system 112 identifies the resources 105 in the form of search results 118 and returns the search results 118 to the user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource (“resource keywords”) or a search query 116 for which search results 118 are requested can also be provided to the content management system 110 to facilitate identification of content that is relevant to the resource or search query 116. A request for a resource 105 or a search query 116 can also include an identifier, such as a cookie, identifying the requesting user device 106 (e.g., in instances in which the user consents in advance to the use of such an identifier).

Based, for example, on data included in the request for content, the content management system 110 can select content items that are eligible to be provided in response to the request, such as content items having characteristics matching the characteristics of a given slot. As another example, content items having selection criteria (e.g., keywords) that match the resource keywords or the search query 116 may be selected as eligible content items by the content management system 110. One or more selected content items can be provided to the user device 106 in association with providing an associated resource 105 or search results 118.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). When multiple slots are allocated in a single auction, the slots can be allocated to a set of bidders that provided the highest bids or have the highest auction scores.

In some implementations, some content providers 108 prefer that the number of impressions allocated to their content and the price paid for the number of impressions be more predictable than the predictability provided by an auction. For example, a content provider 108 can increase the likelihood that its content receives a desired or specified number of impressions, for example, by entering into an agreement with a publisher 109, where the agreement requires the publisher 109 to provide at least a threshold number of impressions (e.g., 1,000 impressions) for a particular content item provided by the content provider 108 over a specified period (e.g., one week). In turn, the content provider 108, publisher 109, or both parties can provide data to the content management system 110 that enables the content management system 110 to facilitate satisfaction of the agreement.

For example, the content provider 108 can upload a content item and authorize the content management system 110 to provide the content item in response to requests for content corresponding to the website 104 of the publisher 109. Similarly, the publisher 109 can provide the content management system 110 with data representing the specified time period as well as the threshold number of impressions that the publisher 109 has agreed to allocate to the content item over the specified time period. Over time, the content management system 110 can select content items based at least in part on a goal of allocating at least a minimum number of impressions to a content item in order to satisfy a delivery goal for the content item during a specified period of time.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 120 which define the content campaign. The content campaign can be created and activated for the content provider 108 according to the parameters 120 specified by the content provider 108. The campaign parameters 120 can be stored in a parameters data store 122. Campaign parameters 120 can include, for example, a campaign name, a preferred content network for placing content, a budget for the campaign, start and end dates for the campaign, a schedule for content placements, content (e.g., creatives), and selection criteria. Selection criteria can include, for example, a language, one or more geographical locations or websites, and one or more selection terms (e.g., keywords). As another example, a content provider 108 can annotate some or all selection criteria with one or more entities. In general, an entity can be named and can represent, for example, a person (e.g., celebrity, president), place (e.g., national park, city), thing (e.g., ice cream, sweater), or concept (e.g., biology, motherhood)). Other examples of entities include a product, service, organization, vertical, or abstract idea. A group or category of entities can be considered to be an entity (e.g., baseball players).

Annotating selection criteria with one or more entities can result in a better user experience than if a more basic matching of selection criteria to a request keyword is performed. For example, for some selection criteria, a simple match of a selection criteria keyword to a request keyword may not result in an appropriate content item being selected for the request. For example, a request keyword may be the word “firing”, which, if a simple match is performed, may be matched to content items having selection criteria related to “firing a weapon”, “firing an employee”, “firing (e.g. igniting) a fireplace”, etc. The content provider 108, who can be, for example, a human resources consulting firm, can, as part of configuring a campaign, associate, for example, an entity that represents a concept of “firing an employee” to a particular content item, group of content items, or a campaign. That way, the content provider's 108 content (e.g., related to firing employees) won't be presented when a request comes in, for example, for a website that relates to pottery (e.g., where “firing” for this type of entity refers more likely to the process of turning the clay into a finished product).

In some implementations, entities can be suggested to the content provider 108, based on selection criteria for a campaign, content of landing pages associated with creatives used in the campaign, content of the creatives, a vertical that is known to be associated with the content provider, etc. The content provider 108 can select one or more suggested entities to use to annotate one or more selection criteria. A content provider 108 can also associate an entity that is not suggested with selection criteria, such as by entering information for an unsuggested entity. In some implementations, one or more inferred entities are automatically associated with selection criteria for the content provider 108. Entity information can be stored in an entities data store 124.

The content management system 110 can use selection criteria and annotated entities when evaluating received requests for content. For example, a search query 116 can be received that includes an entity designation. For example, a user can be provided with and can select one or more entity suggestions for an entered search query 116. As another example, an entity can be inferred from a user-provided search query 116. As yet another example, a search query 116 can be received by a computer system, such as a search submitter system 126, where the received search query 116 is annotated with one or more entity designations. The search submitter 126 can, for example, submit a search query 116 that is annotated with an entity designation determined by a knowledge panel.

The content management system 110 can compare request keywords and a received entity designation to selection criteria and an entity designation associated with a content item. The content management system 110 can determine that a match exists between a content request and a content item, such as by determining that an entity designation associated with the content request matches an entity designation associated with the content item. The content management system 110 can select the content item for the content request and can provide the selected content item to the requesting user device 106. Other examples are possible, such as described in more detail below.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

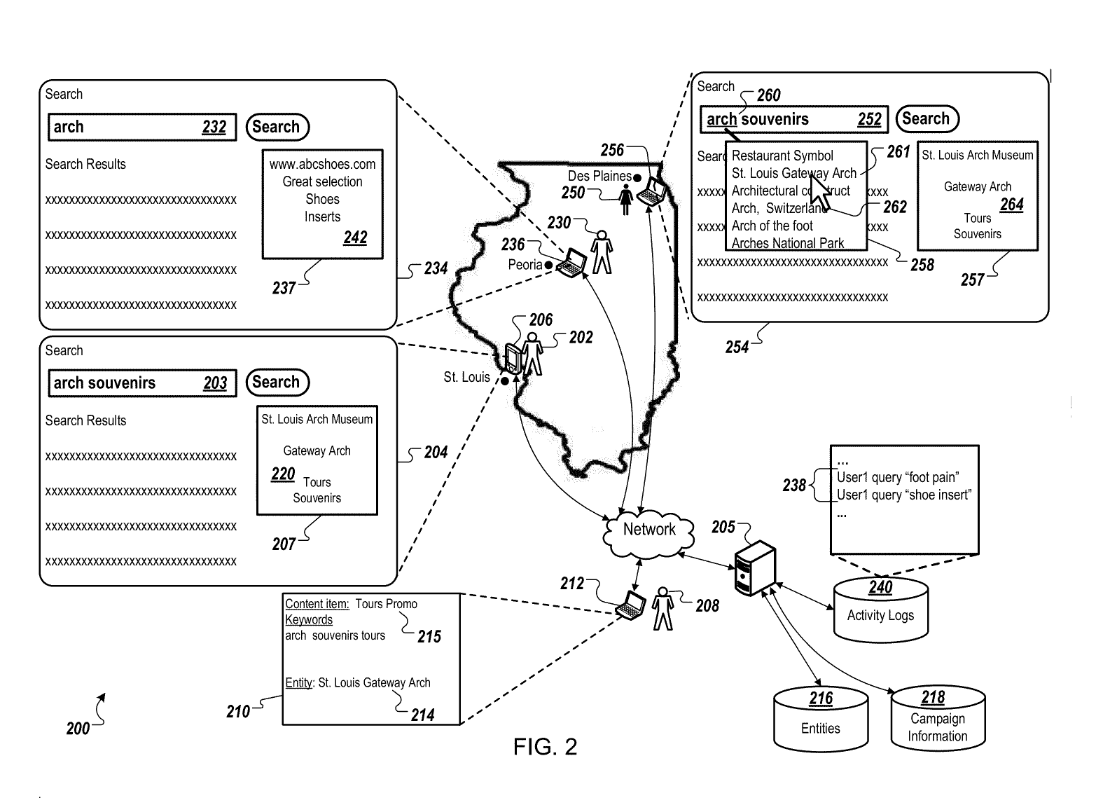

FIG. 2 is a block diagram of an example system 200 for providing content to a user. A user 202 located near St. Louis, Mo. submits a search query 203 (e.g., as shown on a user interface 204) to a content management system 205 using a user device 206. In association with the search query 203, a content request for a content slot 207 can be received by the content management system 205. The content management system 110 can infer an entity of the “St. Louis Gateway Arch” based on an “arch” query term included in the search query 203 and on the user's location near St. Louis. The search query 203 can be matched to a content item associated with a content provider 208 based on the entity “St. Louis Gateway Arch” determined for the search query 203 matching an entity designated by the content provider 208 for the content item.

For example, the content provider 208 may have previously, using a campaign management user interface 210 presented on a content provider user device 212, designated an entity 214 of the “St. Louis Gateway Arch” to be associated with a tours promotion content item 215. The content provider 208 may have entered information for the entity 214, or may have selected the entity 214 from a list of suggested entities. Entity information used for determining suggestions can be retrieved by the content management system 205 from an entities data store 216. Selection criteria and entity designations for selection criteria can be stored for the content provider 208 in a campaign information data store 218. Based on the entity of “St. Louis Gateway Arch” inferred for the search query 203 matching the entity 214, the tours promotion content item 215 can be selected and provided to the user device 206, for presentation on the user device 206 (e.g., as illustrated by a content item 220).

An entity can be inferred based on other factors, such as profile data associated with a user (e.g., user characteristics, user social environment activity, for users who have consented to use of such information), context of the request, content of a page from whence the request originated, or search results associated with the request, to name a few examples. For example, a user 230 located near Peoria, Ill. submits a search query 232 (e.g., as shown on a user interface 234) to the content management system 205 using a user device 236. A request for content associated with the search query 232 can be received by the content management system 205 for a content slot 237. The user 230, in this example, has consented to have at least some user activity stored by the content management system 205. Based on recent user activity 238 for the user 230 accessed from an activity data store 240, the content management system 205 can determine that the user 230 has recent activity related to feet, foot pain, shoe inserts, foot arches, etc. The content management system 205 can infer that the search query 232 relates to an entity “arch of the foot”, and can select a content item for the content slot 237 based at least in part on such a determination. For example, the content slot 237 is presenting a content item 242 for a shoe store that sells shoe inserts.

In some implementations, rather than inferring an entity, one or more entity suggestions are presented to a user and a user selection of one or more suggested entities is received. For example, a user 250 located near Des Plaines, Ill. submits a search query 252 (e.g., as shown on a user interface 254) to the content management system 205 using a user device 256. A request for content associated with the search query 252 can be received by the content management system 205 for a content slot 257.

Entity suggestions 258 can be presented to the user 250 for a query term 260 of “arch”. The entity suggestions 258 include a restaurant symbol (e.g., based on a nearby museum for a restaurant whose symbol relates to arches), the St. Louis Gateway Arch 261, arch as an architectural construct, the city of Arch, Switzerland, and an arch of a foot. The user 250 can select an entity suggestion. For example, as illustrated by a cursor 262, the user 250 can select the entity suggestion 261 of the St. Louis Gateway Arch. The search query 252 and an indication of the selected entity suggestion 261 can be sent to the content management system 205. The content management system 205 can select the content item 215 for the content slot 257 based at least in part on the selected suggested entity 261 matching the entity 214 associated with the content item 215. The content item 215 can be provided to the user device 256, for presentation on the user device 256 (e.g., as illustrated by a content item 264).

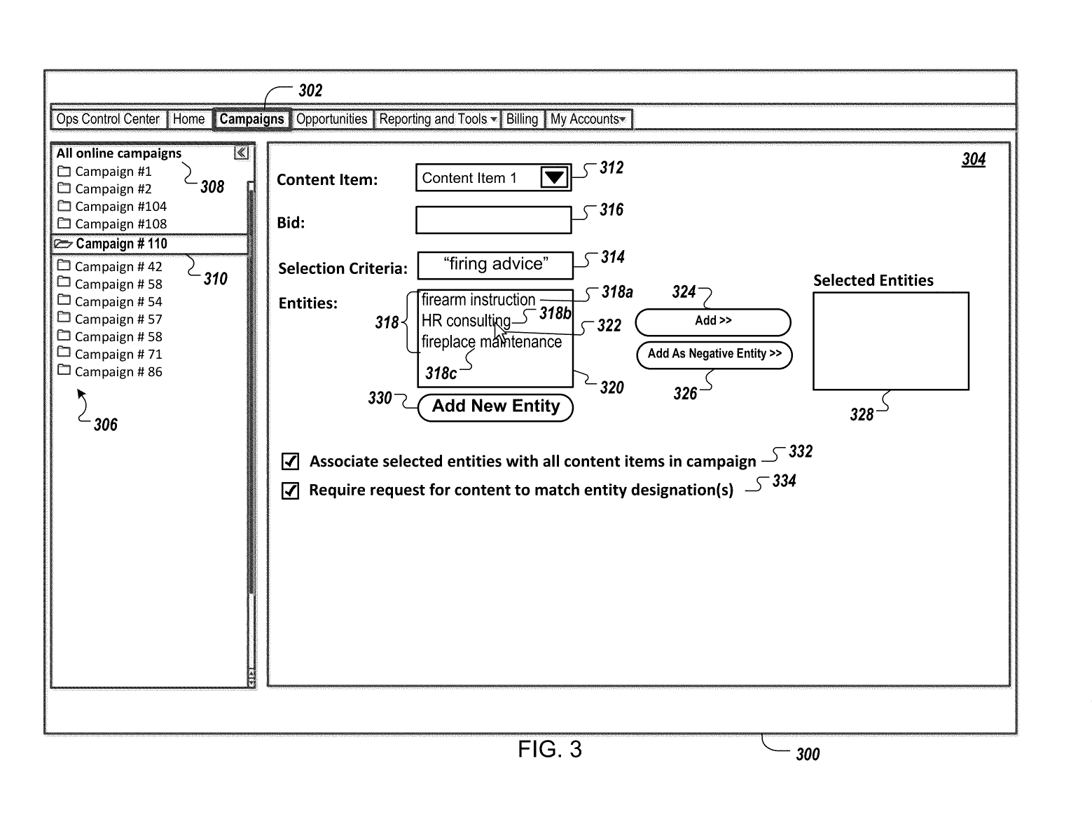

FIG. 3 illustrates an example campaign management user interface 300. The user interface 300 can be included, for example, in one or more user interfaces that a user, such as a campaign sponsor, can use to configure a campaign. The sponsor can select a tab 302 to display a campaign configuration area 304. The sponsor can view a list 306 of campaigns by selecting a control 308. The sponsor can edit an existing campaign in the campaign configuration area 304 by selecting the name of an existing campaign (e.g., a name 310) in the campaign list 306.

The sponsor can select a content item for the campaign using a control 312. Selection criteria and a bid for the content item can be specified using controls 314 and 316, respectively. Entity suggestions 318 for the selection criteria of “firing advice” can be presented to the sponsor in a list control 320. For example, the entity suggestions 318 include entity suggestions 318a-c of “firearm instruction”, “HR (human resources) consulting”, and “fireplace maintenance”. The entity suggestions 318 can be determined, for example, from the selection criteria, based on a landing page associated with the content item, based on a vertical associated with the sponsor, or based on other information known about the sponsor, such as other content items selected or other campaigns.

The sponsor can select an entity suggestion 318 to indicate that the selection criteria are to be annotated with an entity designation associated with the selection. For example, as illustrated by a cursor 322, the user can select the entity suggestion 318b of “HR consulting”. In some implementations, the sponsor can select multiple entity suggestions 318. The sponsor can select an add control 324 to confirm the annotation of the selection criteria with an entity corresponding to the selection. For example, the sponsor can select the add control 324 with the entity suggestion 318b selected to indicate that an entity corresponding to “HR consulting” relates to the content item. An “add-negative” control 326 can be selected to annotate the selection criteria with a negative entity that corresponds to the selection. For example, the sponsor can select the add-negative control 326 with the entity suggestion 318a selected to indicate that an entity corresponding to “firearm instruction” is not related to the content item. In response to selecting either the add control 324 or the add-negative control 326, an indication of a corresponding annotation can be displayed in a control 328.

In some implementations, the sponsor can select an add-new-entity control 330 to annotate the selection criteria with an entity that does not have a corresponding suggestion in the entity suggestions 318. In response to selecting the add-new-entity control 330, a form can be displayed which can be used to enter and/or select information associated with the entity. After completing entry of information for the new entity, an entry for the new entity can be displayed in the control 328.

A control 332 can be selected to associate selected entities with all content items in the campaign. For example, the sponsor can select the control 332 if other content items in the campaign are also related to entities associated with the selected content item. The sponsor can select a control 334 to require that for the content item to be matched to a received request for content, the request needs to match the selected entity designation(s). For example, an entity designation associated with the request can match an entity designation associated with the content item. As another example, an entity-match confidence score which indicates a measure of match between the request for content and the selected entity designation(s) can be determined and a match can be declared when the confidence score exceeds a predetermined threshold. If the control 334 is not selected, the content item can be selected in response to a received request for content even if the entity-match confidence score is below the predetermined threshold. For example, other factors (e.g., requests keywords matching the selection criteria, bid) can boost an overall quality score for the content item to a value which results in the content item being selected for the received request.

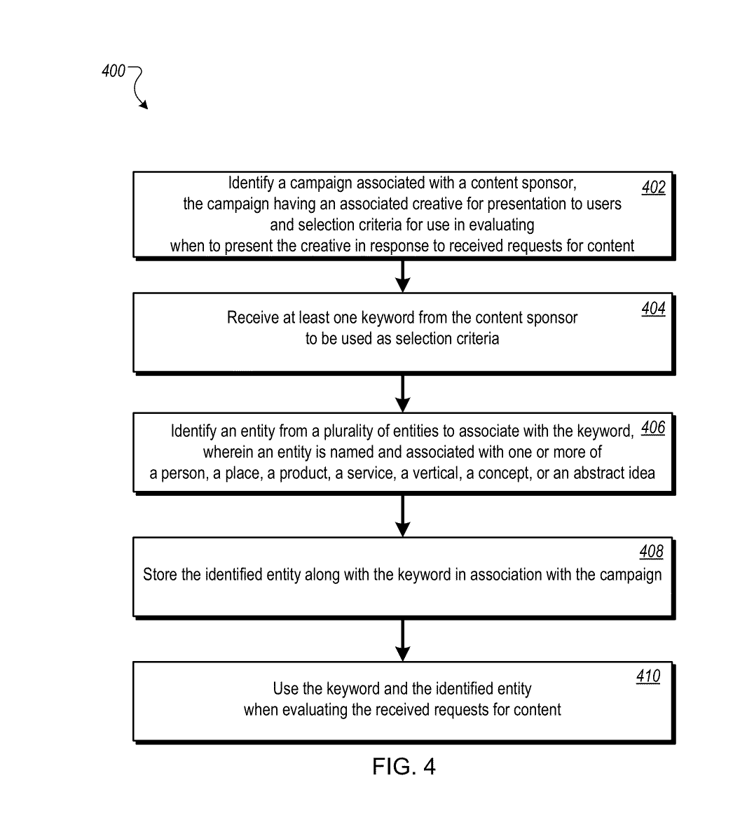

FIG. 4 is a flowchart of an example process 400 for associating an entity with a keyword. The process 400 can be performed, for example, by the content management system 110 described above with respect to FIG. 1.

A campaign associated with a content sponsor is identified (402). The campaign has an associated creative for presentation to users and selection criteria for use in evaluating when to present the creative in response to received requests for content. The selection criteria can include, for example, one or more keywords. The creative can be, for example, an advertisement or some other type of content.

At least one keyword is identified (e.g., received from the content sponsor) to be used as selection criteria (404). The keyword(s) can be received, for example, from a campaign management user interface. One or more of the keywords can be, for example, broad keywords.

An entity is identified from a plurality of entities to associate with the keyword (406). In some implementations, an entity is named and associated with one or more of a person, a place, a product, a service, a vertical, a concept, or an abstract idea. For example, the content sponsor can be prompted to provide an entity and a designation of a sponsor-provided entity can be received from the content sponsor. As another example, a designation of a specific entity can be received from a computing system.

In some implementations, a selection of an entity designation from a set of presented candidate entities can be received from the content sponsor. For example, one or more candidate entities can be identified, such as based on one or more of historical query data, the keyword and other keywords used by the content sponsor in a current or other campaign, content of the creative, information on a landing page associated with the creative, or information derived from image content included in the creative or the landing page. A confidence score for a candidate entity can indicate a likelihood that the candidate entity corresponds to the keyword.

In some implementations, the candidate entities are ranked and a pre-determined number (e.g., five) of top ranking candidate entities are identified. The identified candidate entities can be presented to the content sponsor in an interface so as to enable selection from among the candidate entities. For example, the candidate entities can be presented in a list control or other selection-based user interface control. A selection of an entity from the presented candidate entities can be received and the selected candidate entity can be used as the identified entity. In some implementations, more than one entity designation can be made.

The identified entity is stored along with the keyword in association with the campaign (408). For example, the identified entity can be stored in association with the keyword, the campaign, and a confidence score in a campaign information data store.

The keyword and the identified entity are used when evaluating the received requests for content (410). For example, the entity can be compared to request keywords associated with received requests for content, where the request keywords can be based on search query terms, content of a page from whence a request originated, or search results associated with the request. As another example, the keyword and the identified entity can be used as described below in the description for the process 500.

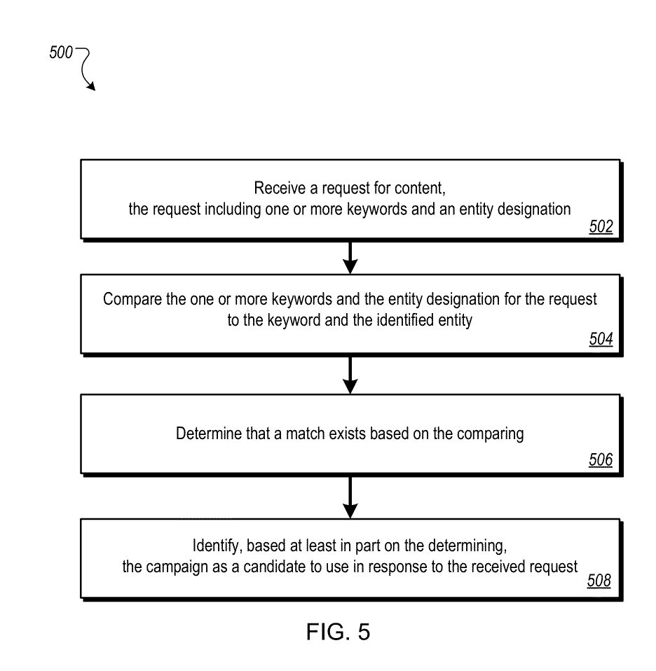

FIG. 5 is a flowchart of an example process 500 for comparing a request entity to a campaign entity. The process 500 can be performed, for example, by the content management system 110 described above with respect to FIG. 1.

A request for content is received (502), the request including one or more request keywords and an entity designation. The entity designation can, for example, be provided by a user. As another example, the entity designation can be inferred and not explicitly provided by the user. For example, the entity designation can be determined based on one or more criteria selected from the group including profile data associated with the user, context of the request, content of a page from whence the request originated, or search results associated with the request. The request keywords can be, for example, search query terms. For example, the request keywords can be “support large pan” and the entity designation can be an entity that represents “panning movement” (e.g., rather than an entity designation that represents “a metal container used for cooking”).

The one or more request keywords and the entity designation for the request (e.g., the “request entity”) are compared to a campaign selection criteria (e.g., keywords) associated with a campaign and with an entity identified as being associated with the campaign keyword (e.g., a “campaign entity”) (504). For example, the one or more request keywords can be compared to the campaign keyword and the request entity can be compared to the campaign entity. In some implementations, a confidence score is determined which indicates a strength of match between the request entity and the campaign entity. In some implementations, a determination is made that the request entity is a negative entity.

A determination is made that a match exists based on the comparing (506). For example, in some implementations, the determination is made that a match exists only when the request entity exactly matches the campaign entity. In some implementations, the determination is made that the match exists based on the confidence score exceeding a predetermined confidence score threshold.

The campaign is identified as a candidate to use in response to the received request, based at least in part on the determining (508). In some implementations, an auction is conducted with all candidate campaigns and a content item to provide is selected based on results of the auction. If the campaign entity is a negative entity, the campaign can be identified as not being a candidate to use in response to the received request based on determining that the request entity matches the response entity.

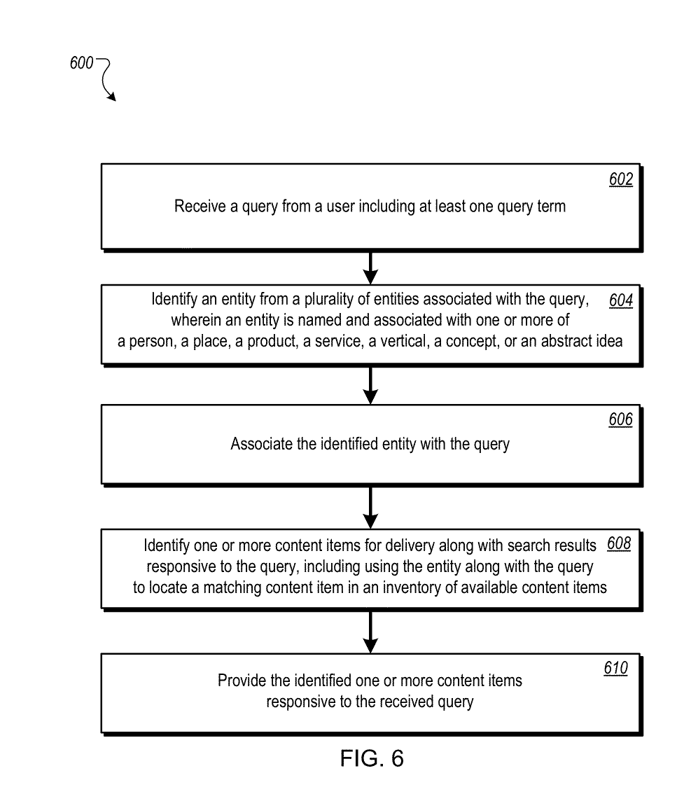

FIG. 6 is a flowchart of an example process 600 for providing content in response to a received request for content. The process 600 can be performed, for example, by the content management system 110 described above with respect to FIG. 1.

A query including at least one query term is received from a user (602). For example, a search query can be received from a user device. In association with the query, a request for content can be received.

An entity is identified from a plurality of entities associated with the query (604). In some implementations, the entity is inferred and not explicitly provided by the user. For example, the entity can be determined based on one or more criteria selected from the group including profile data associated with the user, context of the request, content of a page from whence the request originated, or search results associated with the request. In some implementations, the user can provide the entity (or information indicating the entity). For example, the user can be prompted to provide an entity and a designation of a specific entity can be received from the user.

In some implementations, a user selection of a suggested entity can be received. For example, one or more candidate entities can be identified, such as based at least in part on historical query data. A plurality of candidate entities can be presented to the user in an interface so as to enable selection from among the candidate entities. For example, the candidate entities can be ranked and up to a pre-determined number (e.g., five) of top ranking candidate entities can be presented to the user. A selection of an entity from the presented candidate entities can be received from the user.

The identified entity is associated with the query (606). One or more content items are identified for delivery along with search results responsive to the query (608), wherein identifying one or more content items includes using the entity information along with the query to locate a matching content item in an inventory of available content items. For example, the query and the identified entity can be compared to selection criteria associated with content items in inventory. The identified entity can be compared to respective entity designations associated with respective content items in inventory. A determination can be made that a match exists, such as if the identified entity exactly matches an entity designation associated with a given content item in inventory. A campaign that includes the content item can be identified as a candidate to use when providing the identified one or more content items. An auction can be conducted with all candidate campaigns and a content item to provide can be selected based on results of the auction.

In some implementations, a plurality of entities associated with the query are identified, along with a weight associated with each identified query, where a respective weight indicates a strength of association between a respective entity and the query. In some implementations, a plurality of entity designations associated with a content item can be identified along with a weight associated with each entity designation, where a respective weight indicates a strength of association between the entity designation and the content item. The content item can be identified for delivery, for example, if one or more matches exist between an entity associated with the query and an entity designation associated with the content item. In some implementations, a match can be determined if one or more matches are above a threshold. For example, a calculation can be performed using the weight of an entity associated with the query and a weight associated with an entity designation associated with the content item. For example, a match can be determined if a weight product of a weight of an entity associated with the query times a weight of an entity designation associated with the content item is above a threshold. For example, weights can range from 0 to 1, and the threshold can be 0.5. If, for example, the weight of an entity associated with the query is 0.7 and the weight of an entity designation associated with the content item is 0.8, a weight product of 0.7*0.8 (e.g., 0.56) can exceed the threshold and the content item can be identified for delivery.

The identified one or more content items are provided responsive to the received query (610). For example, the one or more content items can be provided along with the search results.

Although the above description describes a strength of match between an entity associated with a query and an entity designation associated with a content item determining whether the content item is delivered in response to a request for content associated with the query, other actions can be taken based on the strength of match. For example, pricing of selection criteria (e.g., a bid amount for a keyword) can be determined based on the strength of match.

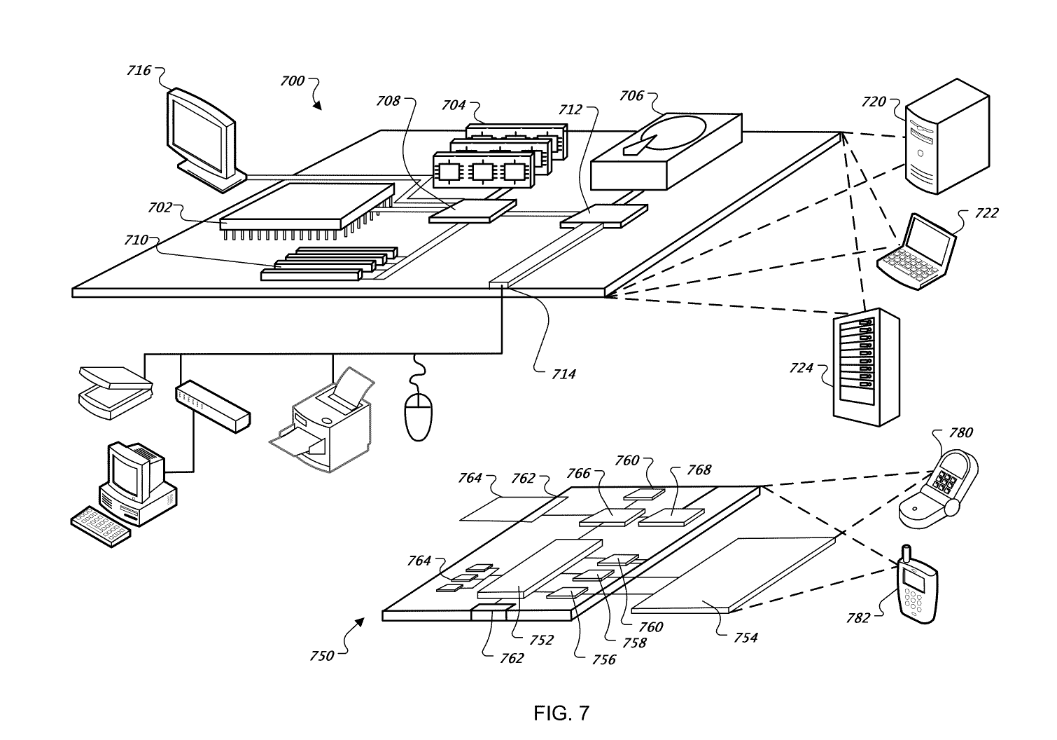

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. The computer-readable medium is not a propagating signal. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is illustrative only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying a campaign associated with a content sponsor, the campaign having an associated creative for presentation to users and selection criteria for use in evaluating when to present the creative in response to received requests for content;
receiving at least one keyword from the content sponsor to be used as selection criteria;
identifying an entity from a plurality of entities to associate with the keyword;
storing the identified entity along with the keyword in association with the campaign; and
using the keyword and the identified entity when evaluating the received requests for content.

2. The method of claim 1 wherein an entity is named and associated with one or more of a person, a place, a product, a service, a vertical, a concept, or an abstract idea.

3. The method of claim 1 wherein the keyword is a broad keyword.

4. The method of claim 1 wherein identifying an entity includes:
identifying candidate entities based at least in part on historical query data;
presenting a plurality of candidate entities to the content sponsor in an interface so as to enable selection from among the candidate entities; and
receiving a selection of an entity from the presented candidate entities and using the selected entity as the identified entity.

5. The method of claim 4 wherein presenting a plurality of candidate entities includes ranking the candidate entities and presenting a pre-determined number of top ranking candidate entities to the content sponsor.

6. The method of claim 1 wherein identifying the entity further includes prompting the content sponsor to provide an entity and receiving from the content sponsor a designation of a specific entity.

7. The method of claim 1 wherein identifying the entity further includes receiving from a computing system a designation of a specific entity.

8. The method of claim 1 further comprising:
receiving a request for content, the request including one or more keywords and an entity designation;
comparing the one or more keywords and the entity designation for the request to the keyword and the identified entity;
determining that a match exists based on the comparing; and
identifying, based at least in part on the determining, the campaign as a candidate to use in response to the received request.

9. The method of claim 1 wherein the identified entity is a negative entity, the method further comprising:
receiving a request for content, the request including one or more keywords and an entity designation;
comparing the one or more keywords and the entity designation for the request to the keyword and the identified entity;
determining that a match exists based on the comparing; and
identifying, based at least in part on the determining, the campaign as not being a candidate to use in response to the received request.

10. The method of claim 8 further comprising conducting an auction with all candidate campaigns and selecting a content item to provide based on results of the auction.

11. The method of claim 8 wherein the entity designation is inferred and not explicitly provided by a user.

12. The method of claim 8 wherein the entity designation is determined based on one or more criteria selected from the group comprising profile data associated with a user, context of the request, content of a page from whence the request originated, or search results associated with the request.

13. The method of claim 8 wherein determining a match includes determining a match only when the identified entity matches the entity designation.

14. The method of claim 1 wherein the creative is an advertisement.

15. A method comprising:
receiving a query from a user including at least one query term;
identifying an entity from a plurality of entities associated with the query;
associating the identified entity with the query;
identifying one or more content items for delivery along with search results responsive to the query, wherein identifying one or more content items includes using the entity along with the query to locate a matching content item in an inventory of available content items; and
providing the identified one or more content items responsive to the received query.

16. The method of claim 15, wherein an entity is named and associated with one or more of a person, a place, a product, a service, a vertical, a concept, or an abstract idea.

17. The method of claim 15 wherein identifying an entity includes:
identifying candidate entities based at least in part on historical query data;
presenting a plurality of candidate entities to a user that submitted the query in an interface so as to enable selection from among the candidate entities; and
receiving a selection of an entity from the presented candidate entities.

18. The method of claim 16 wherein presenting a plurality of candidate entities includes ranking the candidate entities and presenting a pre-determined number of top ranking candidate entities to the user.

19. The method of claim 15 wherein identifying the entity further includes prompting the user to provide an entity and receiving from the user a designation of a specific entity.

20. The method of claim 15 wherein identifying one or more content items further includes:
comparing the query and the identified entity with selection criteria associated with content items in inventory;
determining that a match exists based on the comparing; and
identifying a campaign based on the determining as a candidate to use when providing the identified one or more content items.

21. The method of claim 20 further comprising conducting an auction with all candidate campaigns and selecting a content item to provide based on results of the auction.

22. The method of claim 15 wherein the entity is inferred and not explicitly provided by the user.

23. The method of claim 15 wherein the entity is determined based on one or more criteria selected from the group comprising profile data associated with the user, context of the request, content of a page from whence the request originated, or search results associated with the request.

24. The method of claim 20 wherein determining a match includes determining a match only when the identified entity matches an entity designation associated with a given content item in inventory.

25. A system comprising:
one or more processors; and
one or more memory elements including instructions that when executed cause the one or more processors to:
identify a campaign associated with a content sponsor, the campaign having an associated creative for presentation to users and selection criteria for use in evaluating when to present the creative in response to received requests for content;
receive at least one keyword from the content sponsor to be used as selection criteria;
identifying an entity from a plurality of entities to associate with the keyword;
store the identified entity along with the keyword in association with the campaign; and
use the keyword and the identified entity when evaluating the received requests for content.

26. The system of claim 25 wherein an entity is named and associated with one or more of a person, a place, a product, a service, a vertical, a concept, or an abstract idea.

27. The system of claim 25 wherein the keyword is a broad keyword.

28. The system of claim 25 wherein identifying an entity includes:
identifying candidate entities based at least in part on historical query data;
presenting a plurality of candidate entities to the content sponsor in an interface so as to enable selection from among the candidate entities; and
receiving a selection of an entity from the presented candidate entities and using the selected entity as the identified entity.

29. The system of claim 28 wherein presenting a plurality of candidate entities includes ranking the candidate entities and presenting a pre-determined number of top ranking candidate entities to the content sponsor.

30. The system of claim 25 wherein identifying the entity further includes prompting the content sponsor to provide an entity and receiving from the content sponsor a designation of a specific entity.

31. A computer program product tangibly embodied in a computer-readable storage device and comprising instructions that, when executed by a processor, cause the processor to:
identify a campaign associated with a content sponsor, the campaign having an associated creative for presentation to users and selection criteria for use in evaluating when to present the creative in response to received requests for content;
receive at least one keyword from the content sponsor to be used as selection criteria;
identifying an entity from a plurality of entities to associate with the keyword;
store the identified entity along with the keyword in association with the campaign; and
use the keyword and the identified entity when evaluating the received requests for content.

32. The product of claim 31 wherein an entity is named and associated with one or more of a person, a place, a product, a service, a vertical, a concept, or an abstract idea.

33. The product of claim 31 wherein the keyword is a broad keyword.

34. The product of claim 31 wherein identifying an entity includes:
identifying candidate entities based at least in part on historical query data;
presenting a plurality of candidate entities to the content sponsor in an interface so as to enable selection from among the candidate entities; and
receiving a selection of an entity from the presented candidate entities and using the selected entity as the identified entity.

35. The product of claim 34 wherein presenting a plurality of candidate entities includes ranking the candidate entities and presenting a pre-determined number of top ranking candidate entities to the content sponsor.
